(19) United States
(12) Patent Application Publication
(10) Pub. No.: US 2007/0220726 A1
(43) Pub. Date: Sep. 27, 2007

(54) Tool carrier

(76) Inventor: Mirko Flam, Tischardt (DE)

Correspondence Address: WILLIAM COLLARD;COLLARD & ROE, P.C., 1077 NORTHERN BOULEVARD, ROSLYN, NY, 11576, US

(21) Appl. No.: 11/728,012

(22) Filed: Mar. 23, 2007

(30) Foreign Application Priority Data
Mar. 23, 2006 (DE) 10 2006 013 828.7

(51) Int. Cl. B23B 3/16

(52) U.S. Cl. 29/40; 483/67

(57) ABSTRACT

A tool carrier which possesses at least one accommodation bore for the accommodation, positioning, and releasable fixation of a shaft of a tool holder. The front section of the bore, which section accommodates the shaft of a tool holder, is an exchangeable accommodation part.

### BACKGROUND OF THE INVENTION

1. Field of the Invention

The invention relates to a tool carrier of a machine tool that is used in the cutting machining of work pieces.

2. The Prior Art

Machine tools for cutting machining include lathing machines, milling machines, drilling machines, machining centers, with which lathing, drilling and/or milling can be carried out, as well as lathing devices, milling devices, and drilling devices that can be coupled with lathing machines, milling machines, or drilling machines or machining centers. These machine tools possess one or more tool carriers. At least one of these tool carriers has at least one interface (accommodation), in which a tool holder can be accommodated, positioned, and clamped. Such a tool holder is usually referred to in abbreviated form as an exchange part, in technical terms. The accommodation bores of the tool carrier and of the accommodated region/section/shaft of the tool holder, which are designed to coordinate with one another, are usually referred to as the interface, in technical terms. The tool holder can be a static holder, in other words the tool accommodated in the tool holder does not rotate. On the other hand, the tool holder can also be structured as a so-called driven tool holder, which means that the tool accommodated by the tool holder can rotate about its longitudinal axis, the clamping axis. For this purpose, the tool holder possesses a coupling at the accommodated region. A drive element is assigned to the accommodation bore in question, in the tool carrier, which element can be coupled to the coupling part of the tool holder with its coupling part.

Tool carriers in the sense of the invention are star turrets or planar turrets that can be pivoted about their center axes, from one engagement position into another engagement position. However, tool carriers can also include so-called linear carriers, also frequently referred to as front apparatus in technical terminology.

Over the course of time, different types of interfaces have established themselves on the market, because of the different types of tasks in production technology.

A disadvantage of these established interfaces is that these interfaces are not interchangeable among one another, for the exchange of tool holders on a tool carrier. Some machine tool manufacturers therefore equip their machine tools with tool carriers that have two or more different interfaces. In this way, these machine tools are more variable in use, but the pre-determined engagement positions of the tool carrier are assigned to tools with specific interfaces, which in turn restricts the variability of the machine tools.

### SUMMARY OF THE INVENTION

It is therefore an object of the invention to develop an interface between the tool holder and tool carrier, on a machine tool.

This object is accomplished by means of a tool carrier which possesses at least one accommodation bore for the accommodation, positioning, and releasable fixation of a shaft of a tool holder, wherein the front section of the bore, which section accommodates the shaft of a tool holder, is an exchangeable accommodation part.

One of the significant core points of the new tool carrier consists in the fact that the interface (accommodation bore), which is standardized according to DIN 69880, the so-called VDI-interface, is configured as an accommodation part disposed exchangeably in the body of the tool carrier. The text of DIN 69880 is hereby incorporated by reference. The accommodation part is furthermore kept on hand as a modular set, so that many interface embodiments are also possible.

In one embodiment, the accommodation part is an essentially cylindrical basic body having a flange on one end, and a recess that lies centered relative to the longitudinal body axis, oriented towards the other end, in which the shaft of a tool holder is accommodated. The recess is preferably a passage bore that is configured to accommodate a cylinder shaft of a tool holder according to DIN 69880. In another embodiment, the recess is a stepped basic bore configured to accommodate a tool adapter according to German Patent Application No. DE 20 2004 011 571 U1, the disclosure of which is herein incorporated by reference.

In one embodiment, the accommodation part is the outer housing of a driven tool holder.

In another embodiment, the accommodation part has a front section, and the basic body that follows it has a positioning section having a first larger diameter, a transition section, a guidance section having a second smaller diameter, and an end section having a third diameter along its longitudinal axis.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a detail of one embodiment of the tool carrier, in partial cross-section, which shows a star turret with tool holders accommodated in it, in different embodiments;

FIG. 2 shows details regarding new accommodation parts;

FIGS. 3a to 3d show additional details of an embodiment according to FIG. 2;

FIGS. 4a, 4b show another embodiment of an accommodation part; and

FIGS. 5a, 5b show views of another new tool carrier, a planar turret.

### DETAILED DESCRIPTION OF THE PREFERRED EMBODIMENT

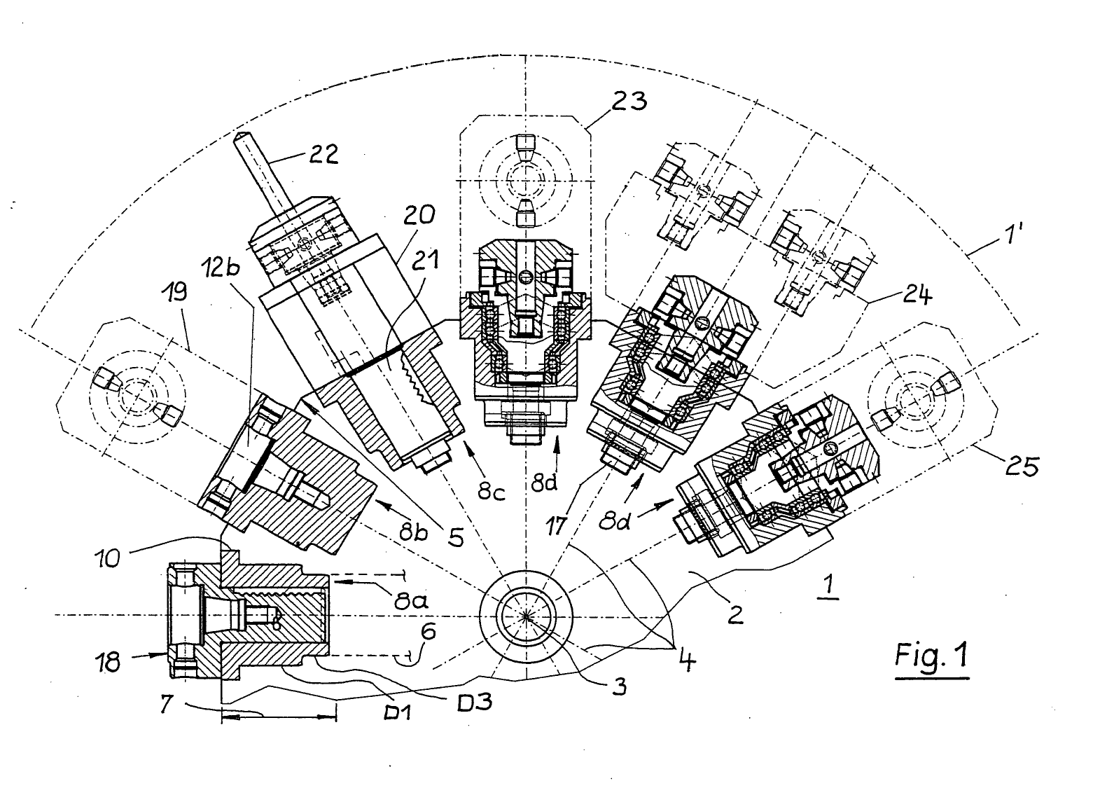

FIG. 1 shows a detail of a tool carrier that is structured in the form of a star turret 1, having a maximal tool flight circle of 1′. The significant details of the present invention in this regard are shown. To make the drawings easier to understand, further components and modules that belong to star turret 1 are not shown here.

The basic body of star turret 1 is a turret disk 2 having an outside diameter 5. Star turret 1 can be pivoted from one pre-determined engagement position to another pre-determined engagement position, about pivot axis 3. The mantle surface of star turret 1 possesses a plurality of planar surfaces. Proceeding from these surfaces, accommodation bores 6 that each extend concentric to pre-determined radial axes 4, into turret disk 2, are disposed. Their front section 7 is an exchangeable accommodation part 8a-8f having a coupling 17.

Each accommodation part 8a-8f possesses a flange 9, 10, 15 at one end, and extends from the flange 9, 10, 15 to the other end, in the form of a cylindrical basic body 11. To accommodate the shaft of a tool holder, a recess 12 is provided in each accommodation part 8a-8f. In order to be able to accommodate tool holders having different shafts, these accommodation parts 8a-8f of a tool carrier are provided in the form of a modular set. Thus, in the case of one accommodation part, recess 12 is structured for the accommodation of a shaft of a tool holder, as a passage bore 12a. This configuration particularly accommodates a shaft 21 of a tool holder 18 that is structured in accordance with DIN 69880, the so-called VDI-interface. Recess 12 could also be configured as a stepped basic bore 12(b) for a basic tool holder 19. According to another embodiment shown in FIG. 1, the accommodation part is the outer housing part of a driven tool holder 20 for a drill 22.

The bodies shown with broken lines in FIG. 1 indicate that the flange 10 of an accommodation part 8c or 8d is configured in such a manner, in one variant, that known tool holders or adapters for tool holders can be set onto the flange 10. For example a combination holder 25 or a dual-axial head 24 or an angled head 23.

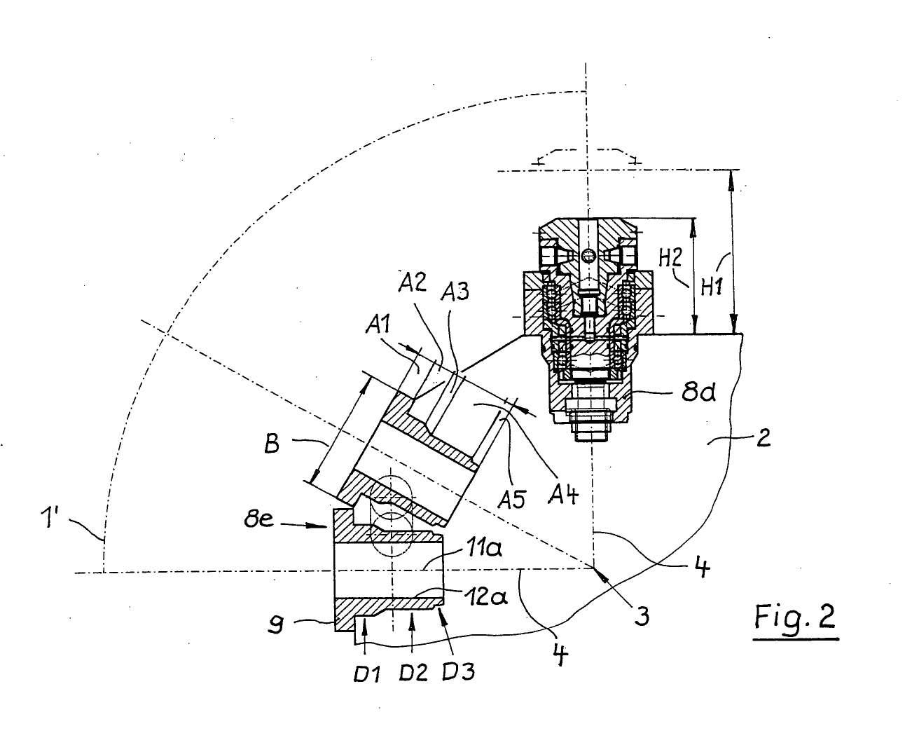

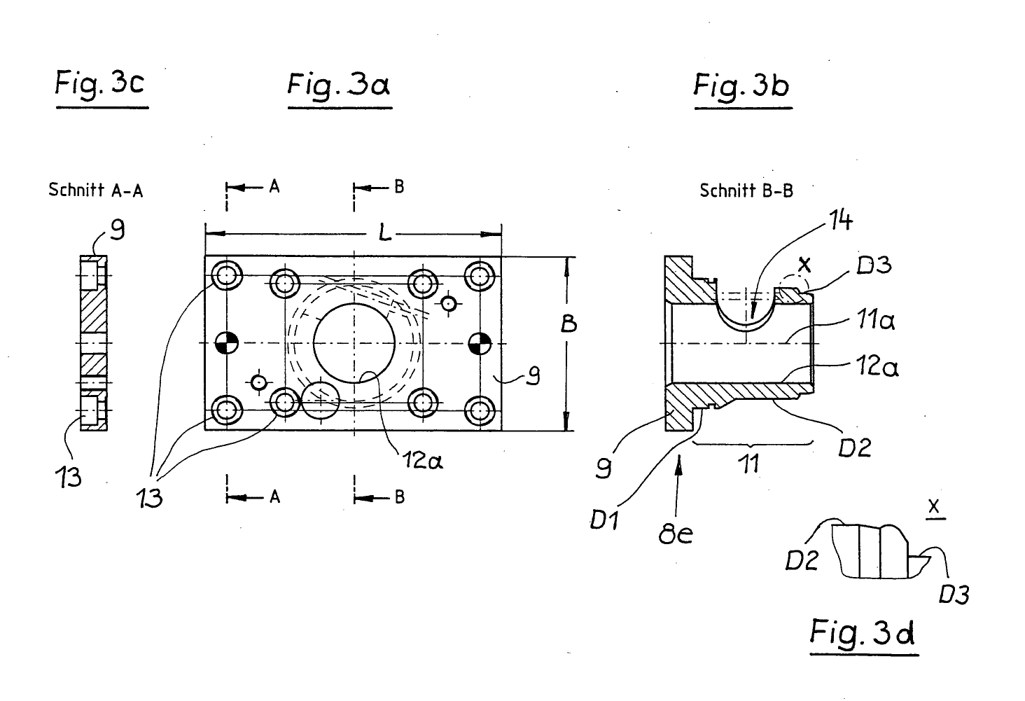

In another embodiment shown in FIGS. 2 and 3a-3d, accommodation part 8e has a front section A1 having a width B, and the basic body 11 that follows it has a positioning section A2, having a first larger diameter D1, a transition section A3, a guidance section A4 having a second smaller diameter D2 and an end section A5 having a third diameter D3 along its longitudinal axis 11a. Accommodation part 8e has countersunk holes 13 set into flange 9, which has a length L. FIG. 3b shows that accommodation part 8e has a perforation 14 in its basic body 11. As shown in FIG. 2, accommodation part 8d has a height H2, which is significantly smaller than a height H1 of a conventionally known tool holder.

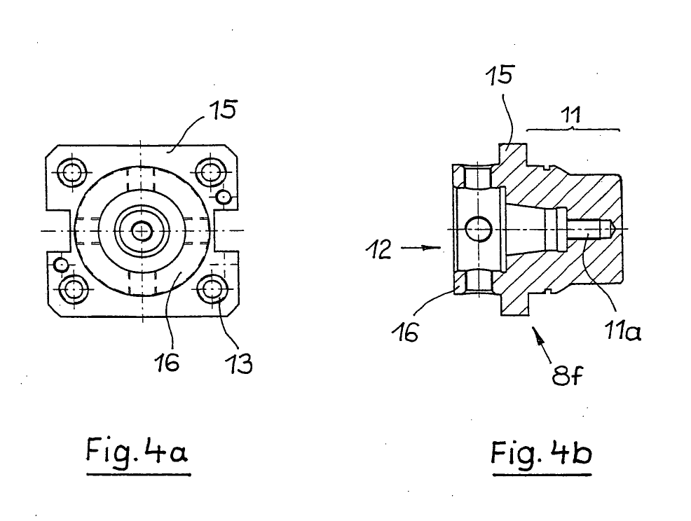

FIGS. 4a, 4b show accommodation part 8f, which has a flange 15, a front extension 16, and countersunk holes 13.

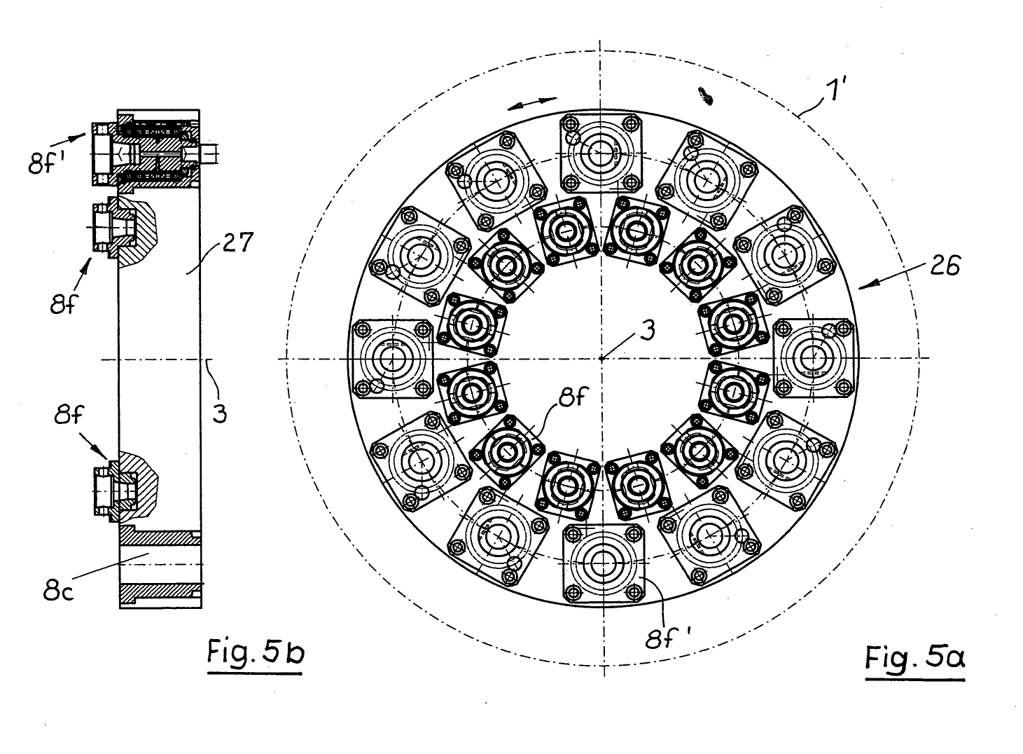

FIGS. 5a and 5b show an alternative embodiment of the tool carrier according to the invention, where the tool carrier comprises a planar turret 26 or having a turret disk 27.

Accordingly, while only a few embodiments of the present invention have been shown and described, it is obvious that many changes and modifications may be made thereunto without departing from the spirit and scope of the invention.
Reference Symbol List
1 star turret (tool carrier)
1′ maximal flight circle of the tools
2 turret disk
3 pivot axis
4 radially directed axes
5 outside diameter of turret disk 2
6 accommodation bore
7 accommodating front section
8a, 8b, 8c, 8d,
8e, 8f, 8f′ accommodation parts
9 flange (rectangular)
10 flange (round)
11 cylindrical basic body
11a longitudinal axis of basic body 11
12 recess
12a passage bore
12b stepped basic bore
13 countersunk holes
14 perforation
15 flange (square)
16 front extension
17 coupling
18 basic holder WFB/VDI
19 basic holder WFB
20 driven tool holder
21 shaft
22 drill
23 angled head
24 dual-axial head
25 combination holder
26 planar turret
27 turret disk
A1 front section (flange)
A2 positioning section
A3 transition section
A4 guidance section
A5 end section
B width of flange 9
D1 first diameter
D2 second diameter
D3 third diameter
L length of flange 9
H1 height of known construction type
H2 height of new construction type

What is claimed is:

1. A tool carrier for a machine tool comprising at least one accommodation bore having a front section that accommodates a shaft of a tool holder for the accommodation, positioning, and releasable fixation of said shaft, wherein said front section comprises an exchangeable accommodation part.

2. A tool carrier according to claim 1, wherein the accommodation part is a cylindrical basic body having a flange on one end, and a recess that lies centered relative to a longitudinal axis of said basic body and is oriented towards the other end of said accommodation part, wherein the shaft of a tool holder is accommodated in said recess.

3. A tool carrier according to claim 2, wherein the recess is oriented longitudinally relative to said basic body and comprises a passage bore.

4. A tool carrier according to claim 3, wherein the passage bore is configured to accommodate a cylinder shaft of a tool holder according to DIN 69880.

5. A tool carrier according to claim 2, wherein the accommodation part comprises an outer housing of a driven tool holder.

6. A tool carrier according to claim 2, wherein the recess is a stepped bore.

7. A tool carrier according to claim 6, wherein the stepped bore is configured to accommodate a tool adapter according to DE 20 2004 011 571 U1.

8. A tool carrier according to claim 2, wherein the accommodation part has a front section, and the basic body has a positioning section having a first diameter, a transition section, a guidance section having a second diameter smaller than said first diameter, and an end section having a third diameter smaller than said second diameter, along its longitudinal axis.
